(19) United States
(12) Patent Application Publication
(10) Pub. No.: US 2008/0021638 A1
(43) Pub. Date: Jan. 24, 2008

(54) Navigation system

(75) Inventor: Tomokazu Kobayashi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/826,700

(22) Filed: Jul. 17, 2007

(30) Foreign Application Priority Data
Jul. 18, 2006 (JP) 2006-196129

(51) Int. Cl. G01C 21/26; G06F 17/30

(52) U.S. Cl. 701/208

(57) ABSTRACT

A service-area road that is a road in a service area such as a rest area or parking area of an expressway is determined to be a road on which a vehicle travels on when the following three conditions are satisfied. A first condition is satisfied when the vehicle travels in an expressway. A second condition is satisfied when a main road of the expressway and the service-area road are designated as candidate roads in map matching process. A third condition is satisfied when a difference between the heading direction of the vehicle and the traffic direction of the main road is equal to or greater than a predetermined value. Thus, it can be as promptly as possible determined that the vehicle is traveling on the service-area road, allowing the vehicle mark to be accurately displayed on the service-area road on the displayed map.

### CROSS REFERENCE TO RELATED APPLICATION

This application is based on and incorporates herein by reference Japanese Patent Application No. 2006-196129 filed on Jul. 18, 2006.

### FIELD OF THE INVENTION

The present invention relates to a navigation system to properly display a position of a subject vehicle, which is located on a road in a service area such as a rest area or a parking area ancillary to an expressway such as a highway or a freeway.

### BACKGROUND OF THE INVENTION

Patent document 1 discloses the following navigation system. When a subject vehicle enters a service area such as a rest area or a parking area of an expressway such as a highway or a freeway, a map matching process may produce an opposite effect to mistakenly locate the position of the vehicle. Thus, the navigation system stops the map matching process.

The vehicle turns in the service area to thereby change an orientation (heading direction) of the vehicle. This sometimes causes the map matching process to fail to accurately locate the vehicle. Namely, the current position of the vehicle may be mistakenly matched on a road (main road or side road of the expressway) other than the road in the service area where the vehicle is actually located. Otherwise, the current position to be displayed on the screen may jump between on multiple candidate roads. Thus, the conventional navigation system stops the map matching process from when the vehicle enters the service area of the expressway to when the vehicle returns to the main road of the expressway.

Patent document 1: JP-H8-292043 A

Here, a current position of the vehicle, which is computed based on various sensor signals, includes a detection error; in addition, a map display may include an error in the displayed position. Therefore, when the map matching process is stopped while the vehicle enters the service area, the current position of the vehicle may be displayed outside of the service area. This mistaken display provides a user with strangeness. Therefore, even when the vehicle enters the service area, it is preferable to continue to perform the map matching process.

In the conventional map matching process, the most possible road is selected based on (i) accordance degree between a vehicle's swept path and road shape and (ii) a distance between the vehicle and a candidate road. However, when a service area is arranged to adjoin a main road of an expressway, a road in the service area and the main road may be similar to each other in shape and position. This may fail to provide a significant difference therebetween to determine a road on which the vehicle actually runs. Therefore, even when the vehicle enters the service area, the navigation system sometimes continues to display the current position of the vehicle such that it is located on the main road. This makes a user feel strange.

While a route guide is performed, a user typically drives the vehicle along the guided route. Here, if multiple candidate roads are retrieved in the map matching process, it is typically designed that a candidate road included in the guided route is preferentially selected from the multiple candidate roads. For instance, while a vehicle is guided along an expressway designated as a guided route, the vehicle may enter a service area. In this case, the current position of the vehicle is apt to continue to appear on the main road of the expressway on the displayed map.

### SUMMARY OF THE INVENTION

It is an object of the present invention to provide a navigation system, in which, when a vehicle enters a service area such as a rest area or parking area of an expressway such as a highway or a freeway, a position of a subject vehicle can be displayed on a road in the service area on the displayed map as promptly as possible.

To achieve the above abject, according to an aspect of the present invention, a navigation system for a vehicle is provided as follows. A display unit is included for displaying a vehicle mark, which indicates a current position and a heading direction of the vehicle, and a vicinity map surrounding the vehicle mark. A measurement unit is included for measuring a current position and a heading direction of the vehicle. A swept path computation unit is included for computing a swept path based on the measured current position. A map data storing unit is included for storing map data. A map matching unit is included for performing a map matching process to determine a road on which the vehicle travels, by comparing the computed swept path with a shape of a road in vicinity of the measured current position. A display control unit is included for causing the display unit to display the vehicle mark and the vicinity map such that the vehicle mark is on a road on which the vehicle travels. Here, on condition that (i) the vehicle travels on an expressway and (ii) candidate roads in the map matching process include a main road of the expressway and a road in a service area branching from the main road, the map matching unit determines that the road in the service area is a road on which the vehicle travels when a difference between the measured heading direction and a traffic direction of the main road is equal to or greater than a predetermined value.

For instance, a vehicle enters a service area that includes a service-area road having a shape similar to that of the main road of an expressway. In this case, the resultant swept path or the distance from the current position of the vehicle is not significantly different from that undergone when the vehicle travels on the main road. Thus, it is difficult to determine which road, the main road or the service-area road, the vehicle travels on. However, in cases that a vehicle is driven to a parking space in the service area, the heading direction of the vehicle is changed from the traffic direction of the main road to a certain direction to thereby further travel to the parking space. Therefore, when the main road and the service-area road are designated as candidate roads in the map matching process, based on the direction difference between the heading direction of the vehicle and the traffic direction of the main road, the service-area road can be determined to be a road on which the vehicle is traveling, as promptly as possible. This allows the current position of the vehicle to properly appear on the service-area road on the displayed map.

According to another aspect of the present invention, a navigation system for a vehicle is provided as follows. Here, the vehicle is supposed to travel an expressway including a main road and a service-area road in a service area ancillary to the expressway. The system comprises: means for measuring a position and a heading direction of the vehicle; means for computing a swept path based on the position; means for storing data on roads including the expressway; means for performing a direction determination as to whether or not a difference between the measured heading direction and a traffic direction of the main road exceeds a threshold value; means for map matching to determine that the service-area road is a travel road, which the vehicle travels on, when the direction determination is affirmed when the main road and the service-area road are designated as candidate roads based on the measured current position, the stored data, and the computed swept path; and means for displaying a mark of the vehicle on the determined travel road on a map surrounding the vehicle.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a schematic configuration of a navigation system according to an embodiment of the present invention;

FIG. 2 is a diagram illustrating a data structure of road data in a map data input unit according to the embodiment;

FIG. 3 is a flowchart diagram illustrating a main routine for displaying a vehicle mark on a road according to the embodiment;

FIG. 4 is a flowchart diagram illustrating a map matching process in FIG. 3 according to the embodiment;

FIGS. 5A, 5B, 5C are diagrams for explaining the map matching process according to the embodiment;

FIG. 6A is a display example of a vehicle mark after a map matching process in a related art; and

FIG. 6B is a display example of a vehicle mark after the map matching process according to the embodiment.

### DETAILED DESCRIPTION OF THE PREFERRED EMBODIMENTS

A navigation system according to an embodiment of the present invention will be explained with reference to drawings.

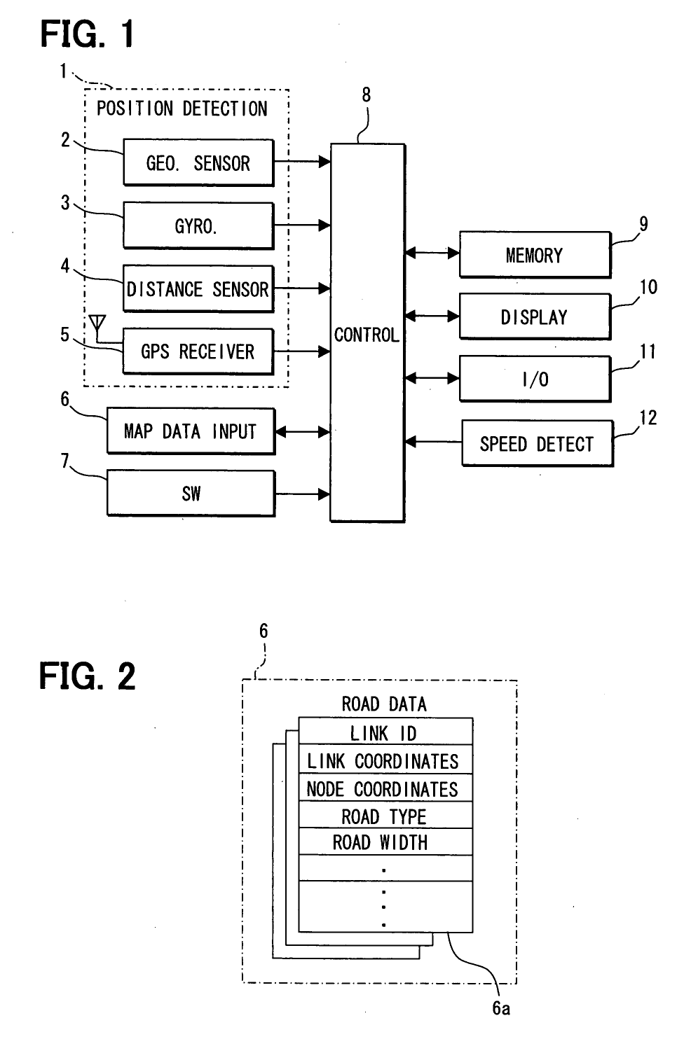

As shown in FIG. 1, a navigation system as the embodiment is provided in a subject vehicle and includes the following: a position detection unit 1, a map data input unit 6, an operation switch group 7, an external memory device 9, a display device 10, an external information input/output device 11, and a control circuit 8 connected with the foregoing components.

The control circuit 8 is a computer to have a known CPU, ROM, RAM, Input/Output (I/O), and a bus line connecting the foregoing parts with each other. The ROM stores a program executed by the control circuit 8. According to the program, the CPU or the like executes predetermined computation.

The position detection unit 1 includes known parts or sensors such as a geomagnetic sensor 2, a gyroscope 3, a distance sensor 4, and a GPS receiver 5 for GPS (Global Positioning System) to measure a position of the vehicle based on electric waves from satellites. These parts have individual detection error types.

Therefore, these parts are used to complement each other. That is, data (current position coordinates and heading direction) on a current position of the vehicle is measured using a hybrid navigation as a combination of satellite navigation due to GPS and autonomous navigation. The autonomous navigation uses the geomagnetic sensor 2, gyroscope 3, and distance sensor 4. Here, depending on required detection accuracy, the position detection unit 1 may include some of the above parts or include another part such as a rotation sensor for steering, or a speed sensor for each following wheel.

The map data input unit 6 is used to input map data including road data, background data, and character data. The map data are typically stored in a storage medium such as a CD-ROM or DVD-ROM; alternatively, it may be stored in a memory card or a hard disk.

The map data may be obtained from an outside server and stored in the external memory device 9. In this case, a navigation function can be performed using the map data stored in the external memory device 9. The navigation function includes a map display for displaying a vicinity map surrounding the vehicle, a display map scale change, a route guide, etc. The function can be achieved by executing various computations in the control circuit 8.

An example of the road data is explained with reference to FIG. 2. As shown in FIG. 2, the road data 6a include the following: a link ID having a number unique to each road; link coordinate data; node coordinate data; road type data indicating road types such as an expressway, highway, national road, etc.; and road width data. The link in the road data 6a is a road segment between two nodes. The node is an intersecting point, a branch point, etc. The link coordinates includes coordinates of a start point and end point of the link. Here, if a node is included within a link, the node coordinate data includes coordinates of the node. The road data 6a is used for providing road shapes when a map matching process is performed and retrieving guide routes to destinations in addition to displaying maps. Further, when retrieving guide routes, road network data indicating connections between roads may be additionally prepared and used.

The background data associate facilities or land shapes on maps with coordinates on the maps. Relating to each facility, a phone number, address, etc. are stored. The character data are used for indicating names of places, facilities, roads, etc. on maps, and are associated with coordinate data corresponding to positions to be displayed.

The operation switch group 7 is used for various inputs and includes a touch-sensitive switch integrated with the display device 10 or mechanical switch. For instance, a destination can be inputted using the operation switch group 7. Thus, the navigation system has a route guide function to automatically select an optimum route from a current position to the inputted destination to form a guide route and display the guide route. The Dijkstra method is known as such a method to automatically designate the most appropriate guide route. Further, using the operation switch group 7, an address, name, or phone number of a desired facility can be inputted. In this case, the navigation system has a retrieval function to retrieve the position of the inputted facility.

The external memory device 9 includes a storage medium such as a memory card or hard disk. The external memory device 9 stores text data, image data, audio data, or the like stored by a user. As explained above, when the map data are obtained from the outside server, the obtained map data are stored in the external memory device 9.

The display device 10 includes, for instance, a liquid crystal display to display a vehicle mark indicating a current position and heading direction of the vehicle and a road map surrounding the vehicle on a screen. The map data is generated using map data inputted by the map data input unit 6. Further, when a destination is designated, a guide route from a current position to the inputted destination is superimposed on the road map.

The external information I/O device 11 is used for receiving road traffic information and transmitting information to outside when needed. The road traffic information is delivered from a VICS (Vehicle Information and Communication System) center via a local FM broadcast station or a beacon laid in a road. The received information is processed in the control circuit 8, and, for instance, road congestion information or road regulation information is displayed to be superimposed on the road map.

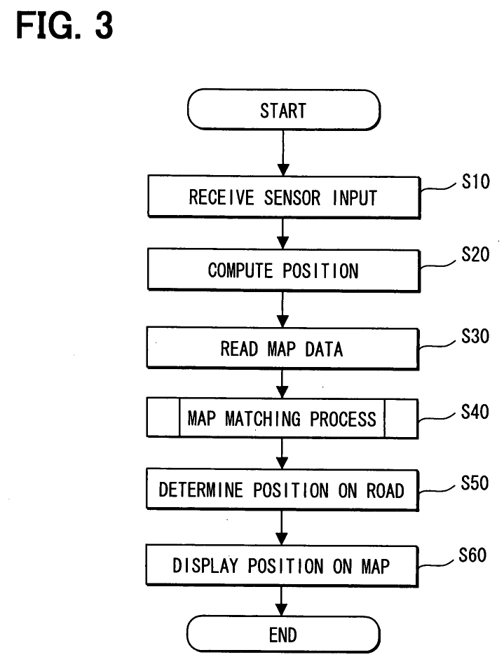

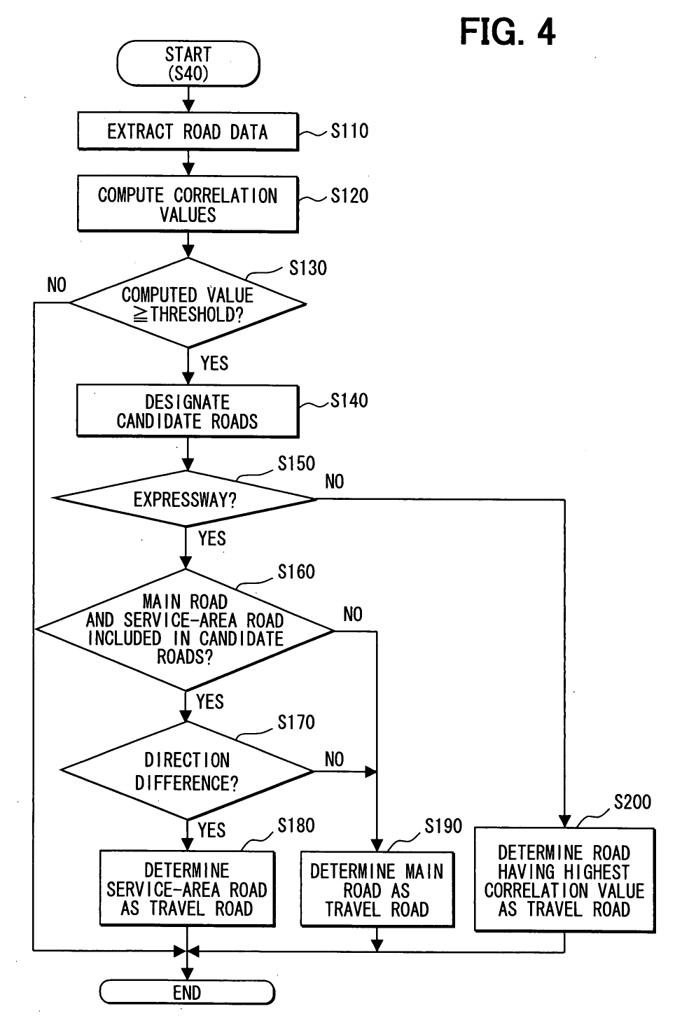

Next, a process as a feature of the embodiment will be explained with reference to FIGS. 3, 4. The process displays a vehicle mark indicating a current position and heading direction of the subject vehicle and a vicinity road map on the display device 10 while performing a map matching process. FIG. 3 is a flowchart diagram illustrating a main routine for determining a travel road which the vehicle travels on using the map matching process and then displaying a vehicle mark on the determined road. FIG. 4 explains the map matching process included in FIG. 3. These processes in FIGS. 3, 4 are repeatedly executed by the control circuit 8 each time a predetermined time period elapses or each time the vehicle travels by a predetermined distance.

As shown in FIG. 3, at Step S10, signals are inputted from individual sensors in the position detection unit 1. At Step S20, based on the inputted signals, a current position and heading direction of the vehicle are computed. Here, the position data by the GPS receiver 5 is obtained in data form similar to coordinate data (longitude and latitude) of the road data. In contrast, data on a heading direction and travel distance of the vehicle is obtained from the geomagnetic sensor 2, gyroscope 3, and distance sensor 4. The obtained data are used for computing coordinate data of a current position based on the previously obtained data or determined data. This is computation of coordinate data using the autonomous navigation. Note that a current position is basically obtained based on the coordinate data computed using the autonomous navigation. Here, when position data are also obtained from the GPS receiver 5, both data are compared with each other. When the difference is equal to or greater than a predetermined distance, the position data from the GPS receiver 5 are used as the current position of the vehicle.

Next, at Step S30, based on the computed coordinates of the current position, map data for a vicinity surrounding the vehicle is read out from the map data. At Step S40, a map matching process is performed. The map matching process extracts, as a candidate road on which the vehicle may travel, a road located within a predetermined distance from the computed current position or a road connected with an already matched road, which has been already matched on the current position, if available. Shape data of a swept path are computed by connecting multiple current positions computed in the past at Step S10 and the latest current position. The shape data of the swept path and individual shapes of the candidate roads are compared with each other and the road having the highest correlation value is determined (or assumed) as a travel road on which the vehicle travels.

Here, computation of the current position and heading direction and computation of the swept path can be only based on position data from the GPS receiver 5 or only based on position data from the autonomous navigation. The map matching process will be explained in more detail later.

When the map matching process determines a travel road on which the vehicle travels, the current position of the vehicle is determined at Step S50 by applying the shape of the swept path on the determined travel road. When the current position of the vehicle is thereby determined, position data are computed using the autonomous navigation on a basis of the determined current position. At Step S60, a vehicle mark indicating a heading direction is accorded to a position corresponding to the determined current position; display data are generated for displaying a vicinity road map; and using the generated display data, the vehicle mark and vicinity road map are displayed on the display device 10.

The map matching process will be explained in more detail with reference to FIG. 4. At Step S110, road data in a vicinity surrounding the current position are extracted based on the current position computed at Step S20. As explained above, the extracted road data are relative to a road located within a predetermined distance from the computed current position or a road connected with an already matched road which has been already matched on the current position, if available.

At Step S120, the swept path data including data of the position and heading direction are updated based on the current position computed at Step S20; further, the updated swept path is compared with the road data extracted at Step S110 to thereby compute a correlation value indicating an accordance degree between the shapes. At Step S130, the computed correlation value is compared with a predetermined threshold value. When the correlation value is equal to or greater than the threshold value, the corresponding road is regarded as a candidate road which can be a target for the map matching process.

When the correlation value is determined to be less than the threshold value at Step S130; the process in FIG. 4 is terminated. In this case, since there is no road data corresponding to the swept path and current position of the vehicle, a map matching process is not performed. The current position of the vehicle is displayed on the display device 10 without amendment (or matching).

When road data with respect to multiple roads are extracted at Step S110, a correlation value of road data relative to each road is computed at Step S120 and the computed correlation value is compared with the threshold value at S130. Thus, multiple candidate roads may be selected at Step S140.

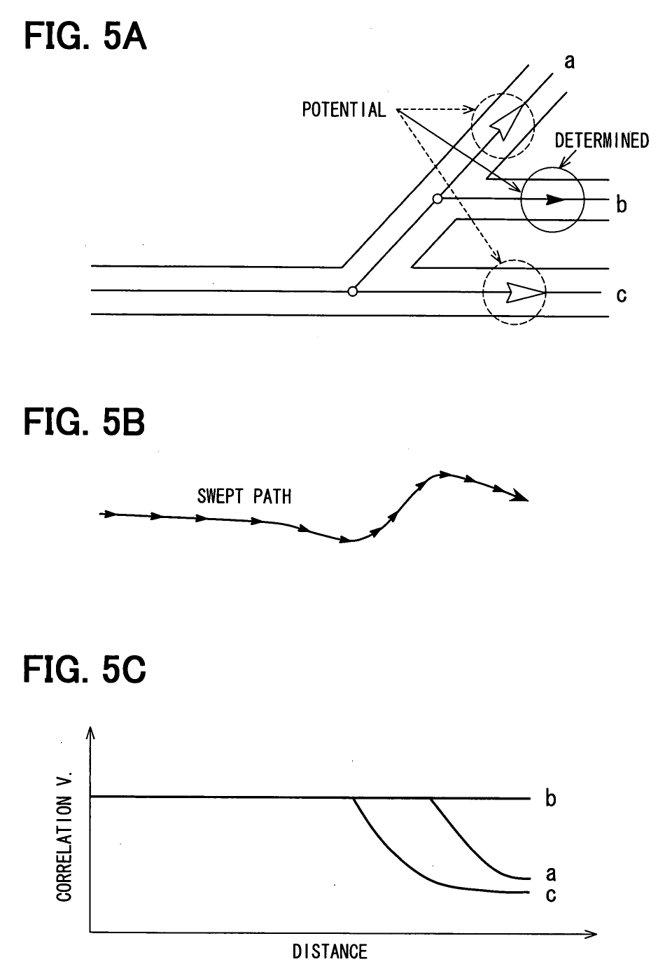

The principle of the map matching process will be explained with reference to FIGS. 5A, 5B, 5C. For instance, all roads connected with an intersection the vehicle has reached are extracted as potential roads the vehicle may subsequently travel on. Referring to FIG. 5A, road data of roads a, b, c as potential roads are extracted. Based on the extracted road data, the corresponding road shape and the swept path (in FIG. 5B) of the vehicle are compared with each other to thereby compute a correlation value (in FIG. 5C) indicating an accordance degree. Then, the road having the highest correlation value among the candidate roads is basically regarded as a travel road on which the vehicle travels. In FIG. 5C, the road b has the highest correlation value; therefore, the vehicle is regarded as traveling on the road b. Thus, the current position of the vehicle is determined to be present on the road b. The above process is repeatedly performed each time a predetermined time period elapses or each time a predetermined distance is traveled by the vehicle to thereby determine current positions on the road.

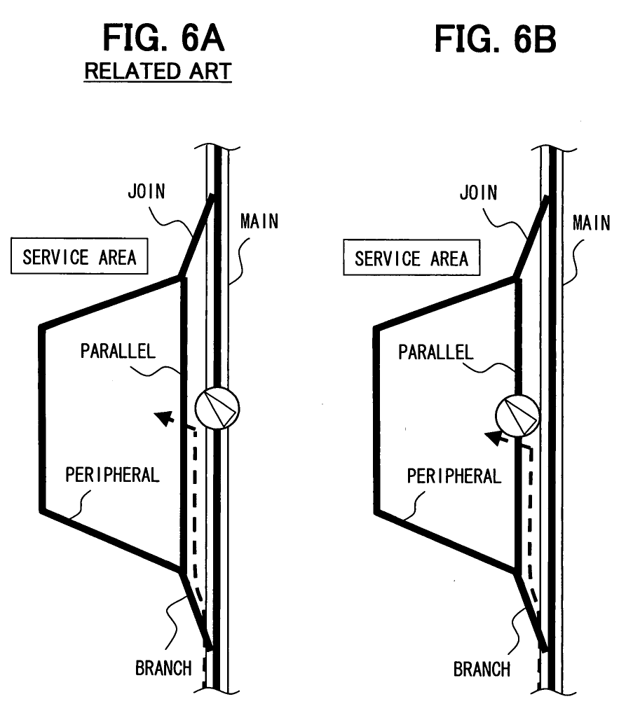

However, when the vehicle enters a service area such as a rest area or parking area during traveling on an expressway, the current position of the vehicle is sometimes mistakenly shown on the main road of the expressway as shown in FIG. 6A. This typically results from the following. A service area such as a rest area or parking area may be arranged to adjoin a main road of an expressway. Here, the main road and a service-area road, which is a road in the service area, are similar to each other in shape and position. This may fail to provide a significant difference therebetween to determine a travel road on which the vehicle actually travels.

As shown in FIG. 6A, road data of the service-area road may include a parallel road substantially parallel with the main road. Here, it is not so easy to accurately determine which road, the main road or parallel road, the vehicle is traveling on. The road data of the service area includes a branch road branching from the main road, a peripheral road along a periphery of the service area, and a join road joining to the main road, as shown in FIG. 6A.

When the vehicle travels on the parallel road and turns, in an intermediate of the parallel road, to a parking space in the service area, the heading direction (i.e., orientation) of the vehicle is changed from the traffic direction of the main road to the direction approaching the parking space. In this case, when the main road and the service-area road are designated as candidate roads in the map matching process, the service-area road is determined to be a travel road on which the vehicle is traveling, based on the direction difference between the heading direction of the vehicle and the traffic direction of the main road. This allows the current position of the vehicle to properly appear on the service-area road in the service area as promptly as possible.

Further, when the heading direction (i.e., orientation) of the vehicle is changed from the traffic direction of the main road to the direction approaching the parking space, the swept path is clearly differentiated from the shape of the main road. If the main road, instead of the service-area road, is still determined to be a travel road, the map matching process takes a longer time to find a proper position, which is located within the service area. That is, a certain position, which is located within the service area and, in addition, departing from the service-area road such as a parallel road, cannot be easily computed directly from the main road of the expressway. The vehicle mark on the displayed map may disappear or jump between multiple candidate roads (e.g., main road, parallel road, or the like), if the worst happens.

In contrast, in cases that the service-area road such as the parallel road is once determined to be a travel road accurately, the map matching process may be able to locate the current position of the vehicle on the certain position as promptly as possible, e.g., using the autonomous navigation. This is an advantage of the embodiment.

To that end, at Steps S150 to S190, the service-area road is determined to be a travel road on which the vehicle travels on when the following three conditions are satisfied. A first condition is satisfied when the vehicle travels in the expressway. A second condition is satisfied when a main road of the expressway and the service-area road are designated as candidate roads in the map matching process. A third condition is satisfied when a difference between the heading direction of the vehicle and a traffic direction of the main road is equal to or greater than a predetermined value. Explanation will be made to Step S150 and subsequent steps.

At Step S150, it is determined based on the road type data of the road data 6a whether the vehicle is traveling on an expressway. When the determination is negated, the vehicle is determined to be traveling on a general road other than an expressway. Then, the process goes to Step S200, where, like a conventional method, the candidate road having the highest correlation value is determined to be a travel road on which the vehicle is traveling. If it has been already determined that the vehicle travels on a service-area road, the determination at Step S150 is negated. Then at Step S200, the service-area road is consecutively determined to be a travel road on which the vehicle travels.

Incidentally, multiple candidate roads may be designated and have similar individual correlation values. In this case, at Step S200, a road having the greatest number of lanes or having the largest width may be preferentially determined to be a travel road on which the vehicle travels. Further, the candidate road closest to the current position of the vehicle may be preferentially determined to be a travel road.

In contrast, when it is determined that the vehicle is traveling on an expressway at Step S150, the process goes to S160. Here, it is determined whether, with respect to the corresponding expressway, the main road and service-area road are designated as candidate roads for the map matching process. Not only when the vehicle enters a service-area road from the main road of the expressway, but also when the main road on which the vehicle is traveling is adjacent to a service area such as a rest area and parking area and a service-area road has a shape similar to that of the main road, the main road and service-area road may be designated as candidate roads.

When the determination at Step S160 is negated, the process goes to Step S190. Here, the main road is determined to be a travel road. In this case, the travel road is determined to be an expressway and a service-area road is not designated as a candidate road for map matching process. Thus, the vehicle is determined to be traveling on the main road of the expressway. In contrast, when the determination at Step S160 is affirmed, the process goes to Step S170. Here, it is determined whether a difference between the heading direction of the vehicle and the traffic direction of the main road of the expressway is equal to or greater than a predetermined value.

When the determination at Step S170 is affirmed, the process goes to Step S180. Here, the service-area road is determined to be a travel road on which the vehicle is traveling. Thus, it can be promptly determined that the vehicle is traveling on the service-area road, allowing the vehicle (i.e., vehicle mark) to be accurately displayed on the service-area road. In contrast, when the determination at Step S170 is negated, the process goes to Step S190. Here, the main road is determined to be a travel road. Thus, until the difference in the directions reaches the predetermined value, the vehicle or vehicle mark continues to appear on the main road of the expressway. This helps prevent the mistaken unnatural display of the vehicle mark on the displayed map. That is, the vehicle (i.e., the vehicle mark), which is actually traveling on the main road, is not mistakenly displayed on a service-area road.

Further, if the vehicle further moves toward a parking space in the service area from the service-area road, a candidate road disappears. In this case, as explained above, the current position computed is used without amendment and the vehicle mark is smoothly and properly displayed on a position corresponding to the computed current position. Here, the current position is computed based on the past current positions previously determined in the service-area road using the autonomous navigation; therefore, the accuracy in the current position is high. Thus, the vehicle mark is not shown outside of the service area.

(Modifications)

In the above embodiment, when the main road and service-area road are designated as candidate roads, a travel road is determined based on only the difference between the heading direction and the traffic direction of the main road. However, in addition to the condition relative to the difference between the directions, another condition may be added. For instance, when the vehicle travels on a service-area road to move to a parking space, the vehicle speed obtained using a speed detection unit 12 is slow compared with a case that the vehicle travels on the main road. Therefore, another condition may be that the vehicle speed is equal to or smaller than a predetermined value.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Features of the subject matter described herein are set out in the following clauses.

As a first feature, a navigation system for a vehicle comprises: a display unit for displaying a vehicle mark, which indicates a current position and a heading direction of the vehicle, and a vicinity map surrounding the vehicle mark; a measurement unit for measuring a current position and a heading direction of the vehicle; a swept path computation unit for computing a swept path based on the measured current position; a map data storing unit for storing map data; a map matching unit for performing a map matching process to determine a road on which the vehicle travels, by comparing the computed swept path with a shape of a road in vicinity of the measured current position; and a display control unit for causing the display unit to display the vehicle mark and the vicinity map such that the vehicle mark is on a road on which the vehicle travels. Here, on condition that (i) the vehicle travels on an expressway and (ii) candidate roads in the map matching process include a main road of the expressway and a road in a service area branching from the main road, the map matching unit determines that the road in the service area is a road on which the vehicle travels when a difference between the measured heading direction and a traffic direction of the main road is equal to or greater than a predetermined value.

For instance, a vehicle enters a service area that includes a road having a shape similar to that of the main road of the expressway. In this case, a swept path or a distance from the vehicle is not significantly different from that undergone when the vehicle travels on the main road. Thus, it is difficult to determine which road, the main road or the road in the service area, the vehicle travels on. However, here, when the vehicle is parked in a parking space in the service area, the heading direction of the vehicle is once changed from the traffic direction of the main road and is moved straight. When the main road and the service-area road are designated as candidate roads in the map matching process, that vehicle is traveling on the service-area road is determined based on the direction difference between the heading direction of the vehicle and the traffic direction of the main road. This allows the current position of the vehicle to properly appear on the service-area road, as promptly as possible.

As an additional feature of the first feature, the road in the service area is indicated in the map data storing unit as a set of a branch road that branches from the main road, a peripheral road that runs along periphery of the service area, and a join road that joins into the main road; and the peripheral road includes a parallel road substantially parallel with the main road. This can effectively obtain an advantage. That is, if the vehicle travels on the branch road and then the peripheral road parallel with the main road, it is difficult to determine which road, the peripheral road or the main road, the vehicle travels on. In such a case, the first feature facilitates the earlier determination that the vehicle is traveling on the peripheral road or service-area road in the service area.

As an another additional feature of the first feature, the map matching unit determines that the vehicle travels on the main road when the difference between the heading direction and the traffic direction of the main road is less than the predetermined value although the candidate roads in the map matching process include the main road and the road in the service-area.

As a yet another additional feature of the first feature, a speed detection unit is configured to detect a speed of the vehicle. Here, the map matching unit determines that the vehicle travels on the road in the service area when the difference is equal to or greater than the predetermined value and, further, the detected speed is equal to or smaller than a predetermined value.

For instance, when the vehicle travels on a service-area road and change its heading direction to move toward a parking space, the speed of the vehicle is smaller than that undergone when traveling on the main road. Thus, considering the vehicle speed facilitates more accurate determination as to whether the vehicle travels on the service-area road.

As a second feature, a navigation system is provided as follows. The system is in a vehicle for traveling an expressway including a main road and a service-area road in a service area ancillary to the expressway. The system comprises: means for measuring a position and a heading direction of the vehicle; means for computing a swept path based on the position; means for storing data on roads including the expressway; means for performing a direction determination as to whether or not a difference between the measured heading direction and a traffic direction of the main road exceeds a threshold value; means for map matching to determine that the service-area road is a travel road, which the vehicle travels on, when the direction determination is affirmed when the main road and the service-area road are designated as candidate roads based on the measured current position, the stored data, and the computed swept path; and means for displaying a mark of the vehicle on the determined travel road on a map surrounding the vehicle.

It will be obvious to those skilled in the art that various changes may be made in the above-described embodiments of the present invention. However, the scope of the present invention should be determined by the following claims.

What is claimed is:

1. A navigation system for a vehicle, the system including:
a display unit for displaying a vehicle mark, which indicates a current position and a heading direction of the vehicle, and a vicinity map surrounding the vehicle mark;
a measurement unit for measuring a current position and a heading direction of the vehicle;
a swept path computation unit for computing a swept path based on the measured current position;
a map data storing unit for storing map data;
a map matching unit for performing a map matching process to determine a road on which the vehicle travels, by comparing the computed swept path with a shape of a road in vicinity of the measured current position; and
a display control unit for causing the display unit to display the vehicle mark and the vicinity map such that the vehicle mark is on a road on which the vehicle travels, wherein
on condition that (i) the vehicle travels on an expressway and (ii) candidate roads in the map matching process include a main road of the expressway and a road in a service area branching from the main road, the map matching unit determines that the road in the service area is a road on which the vehicle travels when a difference between the measured heading direction and a traffic direction of the main road is equal to or greater than a predetermined value.

2. The navigation system of claim 1, wherein
the road in the service area is indicated in the map data storing unit as a set of a branch road that branches from the main road, a peripheral road that runs along periphery of the service area, and a join road that joins into the main road; and
the peripheral road includes a parallel road substantially parallel with the main road.

3. The navigation system of claim 1, wherein
the map matching unit determines that the vehicle travels on the main road when the difference between the heading direction and the traffic direction of the main road is less than the predetermined value although the candidate roads in the map matching process include the main road and the road in the service-area.

4. The navigation system of claim 1, further comprising:
a speed detection unit configured to detect a speed of the vehicle, wherein
the map matching unit determines that the vehicle travels on the road in the service area when the difference is equal to or greater than the predetermined value and, further, the detected speed is equal to or smaller than a predetermined value.

5. A navigation system in a vehicle for traveling an expressway including a main road and a service-area road in a service area ancillary to the expressway, the system comprising:
means for measuring a position and a heading direction of the vehicle;
means for computing a swept path based on the position;
means for storing data on roads including the expressway;
means for performing a direction determination as to whether or not a difference between the measured heading direction and a traffic direction of the main road exceeds a threshold value;
means for map matching to determine that the service-area road is a travel road, which the vehicle travels on, when the direction determination is affirmed when the main road and the service-area road are designated as candidate roads based on the measured current position, the stored data, and the computed swept path; and
means for displaying a mark of the vehicle on the determined travel road on a map surrounding the vehicle.

6. A method of navigating in a vehicle for traveling an expressway including a main road and a service-area road in a service area ancillary to the expressway, the method comprising the steps of:
storing data on roads including the expressway;
measuring a position and a heading direction of the vehicle;
computing a swept path based on the measured position;
performing a direction determination as to whether or not a difference between the measured heading direction and a traffic direction of the main road exceeds a threshold value;
map matching to determine that the service-area road is a travel road, which the vehicle travels on, when the direction determination is affirmed when the main road and the service-area road are designated as candidate roads based on the measured current position, the stored data, and the computed swept path; and
displaying a mark of the vehicle on the determined travel road on a map surrounding the vehicle.
